(19) United States
(12) Patent Application Publication
(10) Pub. No.: US 2005/0213954 A1
(43) Pub. Date: Sep. 29, 2005

(54) Lens-fitted photo film unit of waterproof type

(75) Inventors: Takeshi Masuda, Kanagawa (JP); Hirokatsu Chuman, Kanagawa (JP)

Correspondence Address: YOUNG & THOMPSON, 745 SOUTH 23RD STREET, 2ND FLOOR, ARLINGTON, VA, 22202, US

(73) Assignee: FUJI PHOTO FILM CO., LTD., KANAGAWA (JP)

(21) Appl. No.: 11/090,251

(22) Filed: Mar. 28, 2005

(30) Foreign Application Priority Data
Mar. 26, 2004 (JP) 2004-093276

(51) Int. Cl. G03B 17/02

(52) U.S. Cl. 396/6

(57) ABSTRACT

In a waterproof lens-fitted photo film unit, a lens-fitted photo film unit is contained in a waterproof case. A stop changing button is provided in the waterproof case. When the stop changing button is pressed, the stop changing mechanism in the lens-fitted photo film unit is actuated to become a larger-stop state. The pressing operation to the stop changing button is released to become a smaller-stop state. A shutter-speed changing mechanism switches the shutter speed between high and low. In the preferred embodiment of the present invention, a pressure driving mechanism for actuating the stop changing mechanism when water pressure is applied to a cover body is provided in the waterproof case.

### BACKGROUND OF THE INVENTION

1. Field of the Invention

The present invention relates to a waterproof lens-fitted photo film unit in which underexposure in underwater photographing is prevented.

2. Description of the Prior Arts

A lens-fitted photo film unit is widely well-known as a single-use camera which enables a user to take pictures with ease. A photographic film is preloaded in this lens-fitted photo film unit. After photographing, the lens-fitted photo film unit with the photographic film loaded is brought to a printing shop. Therefore, the lens-fitted photo film unit has advantages that the user does not need to handle the photographic film and it is affordable.

There has been known a waterproof lens-fitted photo film unit which is contained in a waterproof case having a watertight structure so that underwater photographing can be performed. (ex. Japanese Patent Laid-Open Publication No. 2002-365771). The waterproof lens-fitted photo film unit is also used on land such as the seashore.

With respect to the waterproof lens-fitted photo film unit, since sunlight is absorbed in water, there is a problem that a photographic film is underexposured in the underwater photographing when water depth is rather deep.

### SUMMARY OF THE INVENTION

A primary object of the present invention is to provide a waterproof lens-fitted photo film unit in which underexposure in underwater photographing is prevented.

Another object of the present invention is to provide a waterproof lens-fitted photo film unit in which appropriate exposure can be obtained in both underwater photographing and on-land photographing.

In order to achieve the above and other objects, a waterproof lens-fitted photo film unit of the present invention includes an actuator attached to a waterproof case. The actuator operates an exposure value changing mechanism from outside of the waterproof case. The exposure value changing mechanism is set to a large exposure value in on-land photographing, while it is set to a small exposure value in underwater photographing. In the large exposure value, an exposure amount becomes small. Meanwhile, in the small exposure value, the exposure amount becomes large. The actuator operates the exposure value changing mechanism in accordance with manual operation or water pressure.

In a preferred embodiment of the present invention, a film to be deformed by the water pressure is attached to the waterproof case. A hard protrusion is provided inside of the film. The protrusion moves while the film is elastically deformed by the water pressure, so as to actuate the exposure value changing mechanism.

In the large exposure value, the exposure value changing mechanism keeps a smaller-stop state in which a size of an aperture stop is small, while in the small exposure value it keeps a larger-stop state in which the size of the aperture stop is large. The exposure value is changed by inserting or retracting a stop plate having a small size opening in/from a photographing optical axis.

In another embodiment of the exposure value changing mechanism, shutter speed is high in the large exposure value, while it is low in the small exposure value.

In further embodiment of the exposure value changing mechanism, a ND filter provided inside the waterproof case is inserted in or retracted from the photographing optical axis.

A photographic film having a high sensitivity of at least ISO 800 is preloaded in the lens-fitted photo film unit.

According to the waterproof lens-fitted photo film unit of the present invention, the exposure value changing mechanism can be operated from outside of the waterproof case, so that the exposure value can be changed to become small in the underwater photographing in which a light amount is small.

In addition, since the exposure value changing mechanism is automatically actuated to change the exposure value based on the pressure applied to the waterproof case, the operation for changing the exposure is not required.

### BRIEF DESCRIPTION OF THE DRAWINGS

The above and other subjects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is a perspective view of a waterproof lens-fitted photo film unit of a first embodiment;

FIG. 2 is an exploded perspective view of a lens-fitted photo film unit and a stop changing button;

FIG. 3 is an exploded perspective view showing a structure of a stop changing mechanism;

FIG. 4A is a front view of a changeover ring and a stop-changing plate in a smaller-stop state;

FIG. 4B is a side view of an extended portion of the changeover ring in the smaller-stop state;

FIG. 5A is a front view of the changeover ring and the stop-changing plate in a larger-stop state;

FIG. 5B is a side view of an extended portion of the changeover ring in the larger-stop state;

FIG. 6A is an exploded perspective view showing a structure of a stop changing mechanism and a shutter-speed changing mechanism of a waterproof lens-fitted photo film unit of a second embodiment;

FIG. 6B is an enlarged view of the relevant portion of a lens holder and a shutter-speed changing lever shown in FIG. 6A;

FIG. 7A is a front view of a changeover ring and a stop-changing plate in a smaller-stop/high-speed shutter state;

FIG. 7B is a side view of an extended portion of the changeover ring in the smaller-stop/high-speed shutter state;

FIG. 8A is a front view of the changeover ring and the stop-changing plate in a larger-stop/low-speed shutter state;

FIG. 8B is a side view of the extended portion of the changeover ring in the larger-stop/low-speed shutter state;

FIG. 9A is a plan view of a shutter-speed changing lever in a high-speed shutter state;

FIG. 9B is a plane view of the shutter-speed changing lever in a low-speed shutter state;

FIG. 10A is a front view of the changeover ring and a shutter blade in a smaller-stop/high-speed shutter state;

FIG. 10B is a front view of the changeover ring and the shutter blade in the larger-stop/low-speed shutter state;

FIG. 11A is a cross-sectional view showing a variation in that exposure value is changed according to external pressure in a state when on-land photography;

FIG. 11B is a cross-sectional view showing a variation in that exposure value is changed according to external pressure in a state when underwater photographing; and

FIG. 12 is an exploded perspective view of a waterproof lens-fitted photo film unit of a third embodiment which has a filter changing mechanism.

### DETAILED DESCRIPTION OF THE PREFERRED EMBODIMENTS

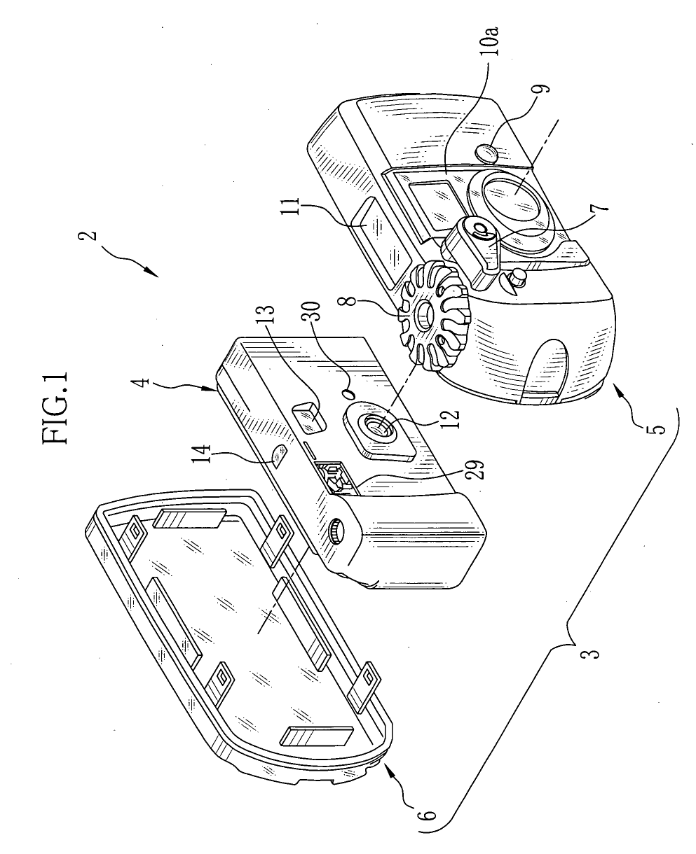

As shown FIG. 1, a waterproof lens-fitted photo film unit 2 is constituted of a waterproof cover 3 molded of plastic and a lens-fitted photo film unit 4 contained in the waterproof cover 3 in a watertight manner. The waterproof cover 3 is constituted of a cover body 5 for covering front and side surfaces of the lens-fitted photo film unit 4, and a lid 6 for covering a rear surface. The cover body 5 is provided with a release lever 7, a winding knob 8, and a stop changing button 9. Further the cover body 5 is formed with a front window 10 and a top window 11. The cover body 5 is molded of opaque plastic, whereas the front window 10 and the top window 11 are made of transparent plastic. The lid 6 is also made of the transparent plastic. A contact portion of the lid 6 and the cover body 5 is provided with rubber packing in order to keep a watertight property.

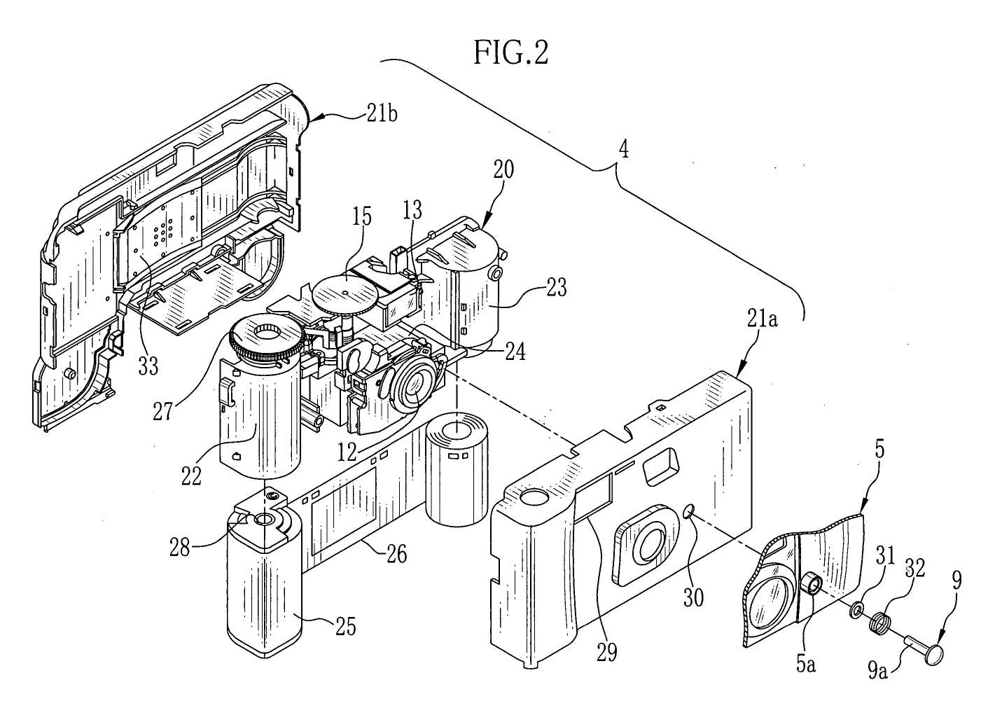

A front surface of the lens-fitted photo film unit 4 is provided with a taking lens 12 and a viewfinder lens 13, which are exposed thereon and face the front window 10. A top face of the lens-fitted photo film unit 4 is provided with a counter indicator window 14 for displaying a residual photographable number with use of a scale on a counter disk 15 (see. FIG. 2). The counter indicator window 14 faces the top window 11 of the cover body 5, so that the user can confirm the photographable number from the outside of the waterproof case 3.

In FIG. 2, the lens-fitted photo film unit 4 is constituted of a body base 20 and front and rear covers 21a, 21b, which are molded of black plastic. The body base 20 has a photographing mechanism incorporated therein. The front and rear of the body base 20 are respectively covered by the front and rear covers 21a, 21b. An upper portion of the body base 20 is provided with a shutter charge mechanism, a film winding stop mechanism, a film counter mechanism, a viewfinder optical system and so forth. Moreover, side portions of the body base 20 are integrally formed with a cartridge chamber 22 and a film chamber 23. A light-shielding tube 24 is provided on the body base 20 behind the taking lens 12.

A photographic film 26 drawn out of a film cartridge 25 is contained in the film chamber 23 with wound into a roll shape. The film cartridge 25 is contained in the cartridge chamber 22. A take-up gear 27 is provided on an upper portion of the cartridge chamber 22, and a lower end of the take-up gear 27 engages with a spool 28 of the film cartridge 25. Further, the take-up gear 27 meshes with an axis of the winding knob 8 to rotate the spool 28 according to a rotation of the winding knob 8. The photographic film 26 contained in the film chamber 23 is taken up toward the film cartridge 25 by rotating the spool 28, and in accordance with the movement, shutter charge is performed.

The front cover 21a is formed with openings through which the taking lens 12 and the finder lens 13 are exposed, an opening 29 through which the shutter charge mechanism is exposed, and a hole 30 through which the stop changing mechanism is partly exposed. When the release lever 7 is operated, the shutter release is performed by movement of the shutter release mechanism.

A columnar bar member 9a is provided on a rear surface of the stop changing button 9. The front surface of the cover body 5 is formed with a boss 5a having a through-hole in the central portion thereof. A ring-shaped packing 31 is tilted in the hole of the boss 5a. A coiled spring 32 is fitted on an outer circumference of the boss 5a. The bar member 9a is inserted into the hole of the boss 5a through the packing 31 to penetrate through the cover body 5. The packing 31 allows sliding movement of the bar member 9a against the cover body 5, with keeping the watertightness between the boss 5a and the bar member 9a.

The spring 32 biases the stop changing button 9 forward to return the stop changing button 9 to the initial position when the pressing operation of the stop changing button 9 is released. Since a front end portion of the bar member 9a is inserted in the hole 30 of the front cover 21a, the operation of the stop changing button 9 is transmitted to the stop changing mechanism. If the stop changing button 9 is pressed, a size of an aperture stop behind the taking lens 12 is changed by the stop changing mechanism.

The rear cover 21b covers the rear portions of the cartridge chamber 22 and the film chamber 23 so as to shield the preloaded photographic film 26 from the light, and forms a film passage between both chambers 22 and 23 with a film guide 33.

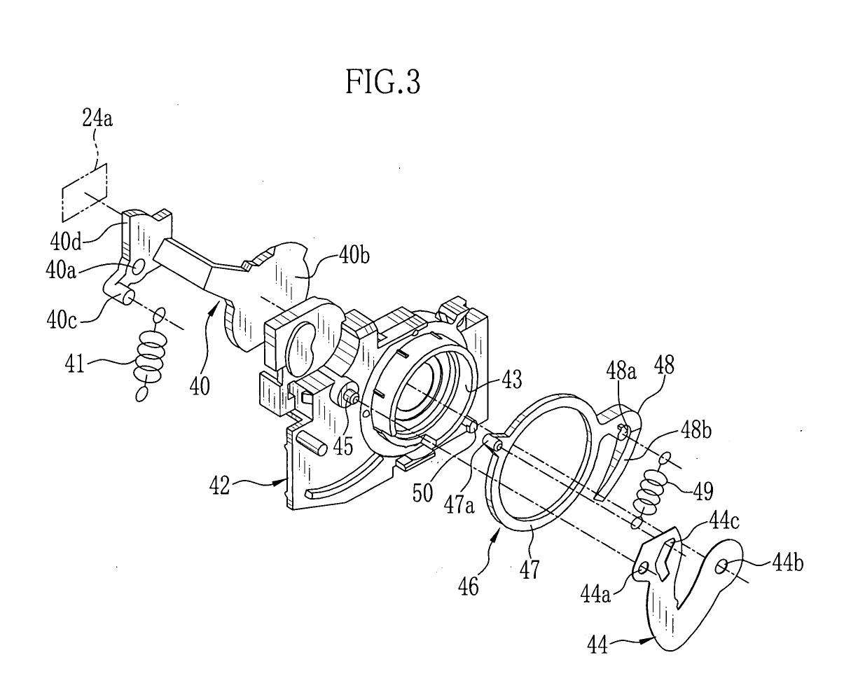

FIG. 3 shows a shutter mechanism and the stop changing mechanism. A shutter blade 40 is provided with a hole 40a in which a pin is inserted so as to become a center of swing, an open-close portion 40b for opening and closing the exposure aperture 24a, a pin 40c on which one end of a spring 41 is hooked, and a protruding portion 40d to be kicked by a shutter drive lever (not shown).

The shutter blade 40 is biased by the spring 41 to be set in a closed position to cover the exposure aperture 24a. If the release lever 7 is operated, the protruding portion 40d is kicked rightward by the shutter drive lever, and then the open-close portion 40b is rotated in a clockwise direction against the biasing of the spring 41. Thereby, the exposure aperture 24a is opened to expose the photographic film 26.

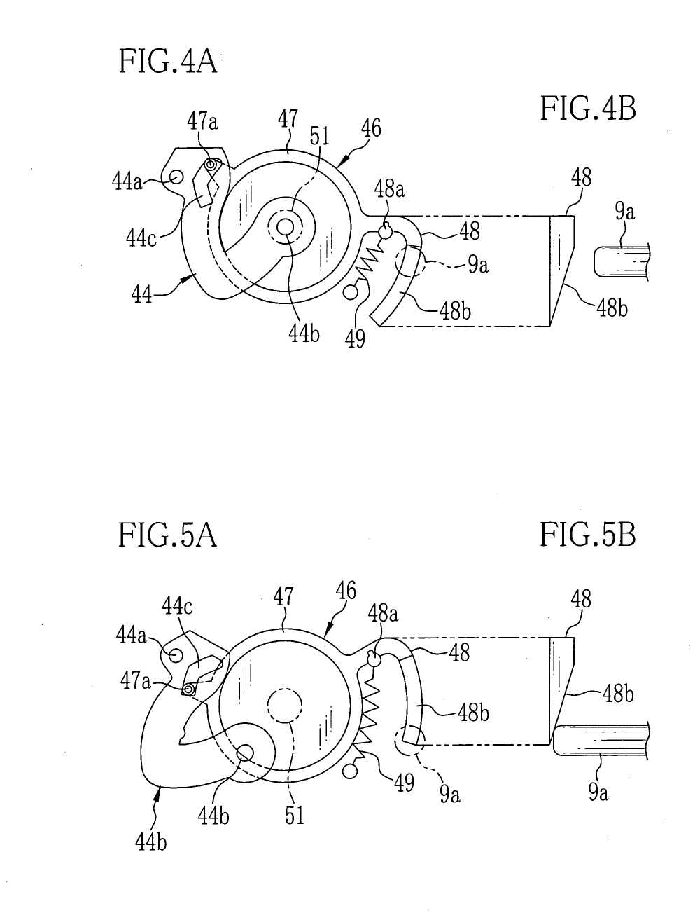

A cylindrical lens barrel 43 and a pin 45 are provided in the lens holder 42. The lens barrel 43 contains the taking lens 12, a stop plate formed with a large aperture 51 (see FIG. 4A) which is positioned behind the taking lens 12, and so forth. The pin 45 swingably supports a stop-changing plate 44 having an approximately L-like shape. In FIG. 3, the taking lens 12 and the stop plate are omitted. The pin 45 is inserted into a hole 44a of the stop-changing plate 44 so that the stop-changing plate is swingably supported in front of the lens holder 42. The stop-changing plate 44 is inserted in or removed from the lens barrel 43 through a cut portion thereof. The stop (f-number) is changed by selectively inserting or removing a small aperture 44b in/from a photographing optical axis. Note that a lens holding plate (not shown) for holding the taking lens 12 is attached to the front of the lens holder 42.

The changeover ring 46 is rotatably fitted around the lens barrel 0.43. The changeover ring 46 is constituted of a ring portion 47 and an extended portion 48 extending outside from the ring portion 47. The ring portion 47 is provided with a link pin 47a to be inserted to a crooked slit 44c of the stop-changing plate 44. A spring-hang pin 48a is provided close to a foot of the extended portion 48. The extended portion 48 is bent in a concentric circular-arc with the ring portion 47. The circular-arc portion is formed with a pressing surface 48b to be pressed by the bar member 9a of the stop changing button 9. The thickness of the circular-arc portion of the extended portion 48 becomes thinner toward the clockwise direction. The pressing surface 48b tilts with respect to the moving direction of the bar member 9a (see FIGS. 4B and 5B).

Another end of the spring 49 is hanged on a pin 50 formed on a lower portion of the front surface of the lens holder 42 so as to bias the changeover ring 46 in the clockwise direction. Note that the changeover ring 46 biased by the spring 49 is kept in the initial position.

FIGS. 4A and 4B show the changeover ring 46 and the stop-changing plate 44 in the initial position. Since the stop changing button 9 is not pressed, the bar member 9a is away from the extended portion 48. When the changeover ring 46 exists in the initial position, the stop-changing plate 44 enters to the lens barrel 43, so that the small aperture 44b is disposed on the photographing optical axis. The stop plate formed with the large aperture 51 is set in the lens barrel 43. When the small aperture 44b overlaps the large aperture 51, the small aperture 44b is enabled to make the aperture smaller.

As shown in FIG. 5B, since the pressing surface 48b tilts with respect to the moving direction of the bar member 9a, the extended portion 48 slides vertically to the pressing direction of the pressing surface 48b according to a pressing amount of the bar member 9a. Thereby, if the stop changing button 9 is pressed from the outside of the cover body 5, the bar member 9a presses the pressing surface 48b to rotate the changeover ring 46 in a counterclockwise direction. The slit 44c is pressed by the link pin 47a according to the rotation of the changeover ring 46, and then the stop-changing plate 44 rotates in the clockwise direction to retract from the optical axis, so that the large aperture 51 is enabled to make the aperture larger.

The slit 44c has a shape formed by combining two arcs, one of which is concentric with the ring portion 47 of the changeover ring 46 when the stop-changing plate 44 exists in the smaller-stop position, and the other of which is concentric with the ring portion 47 when the stop-changing plate 44 exists in the larger-stop position. Thereby, the stop-changing plate 44 does not swing even if the changeover ring 46 is slightly rotated due to vibration, a shock, an operational error of the user, and so forth. Thus, it is prevented to perform photographing in a state that the stop-changing plate 44 is stopped at a halfway position.

For example, a high sensitive film of ISO 800 is used as the photographic film 26, and the shutter speed is set at 1/140 seconds. The f-number of the small aperture state in which the stop changing button 9 is not pressed is f10 (large exposure value mode), whereas the f-number of the large aperture state in which the stop changing button 9 is pressed is f5.6 (small exposure value mode). The f-number can be changed by pressing the stop changing button 9 or without doing that. Namely, the on-land photography is preferably performed in the large exposure value mode without pressing the stop changing button 9, while the underwater photographing is preferably performed in the small exposure value mode with pressing the stop changing button 9. Therefore, the underexposure in the underwater photographing is prevented.

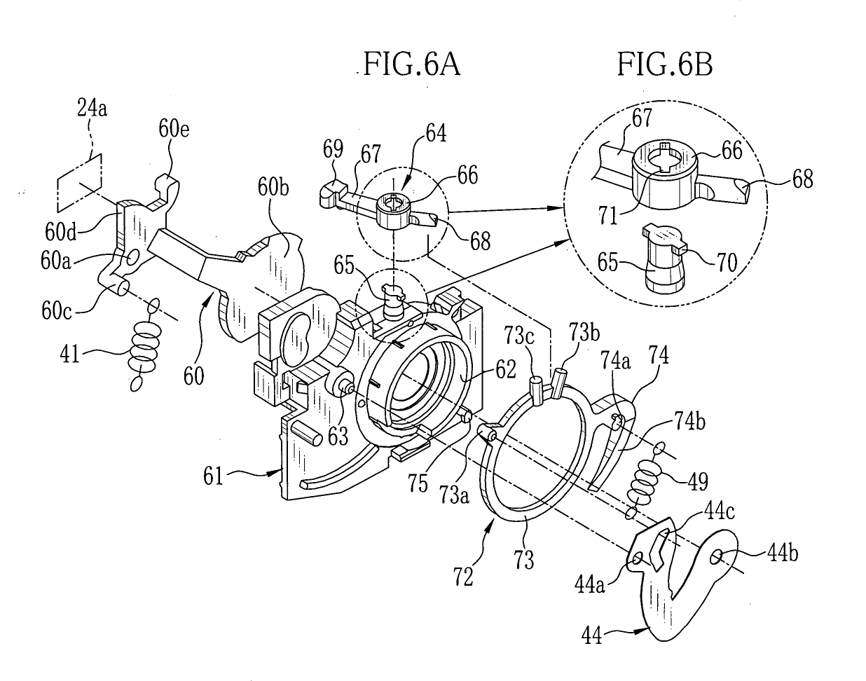

Next, as a second embodiment, a waterproof lens-fitted photo film unit in which both the stop and the shutter speed are changed according to the operation of the stop changing button 9 is explained in reference to FIGS. 6A and 6B. In the second embodiment, components same as those in the first embodiment are represented by same numbers.

As with the first embodiment, a shutter blade 60 is provided with a hole 60a in which a pin is inserted, an open-close portion 60b for opening and closing the exposure aperture 24a, a pin 60c on which one end of the spring 41 is hooked, and a protruding portion 60d to be kicked by the shutter drive lever. In addition, the shutter blade 60 has a collision protrusion 60e.

A shaft 65 is formed in an upper portion of the lens holder 61 to swingably support a shutter-speed changing lever 64. The shutter-speed changing lever 64 is constituted of a boss 66 supported by the shaft 65, a rotatable arm 67 and a projecting piece 68 protruding from a side surface of the boss 66, and a pad 69 formed in an end of the rotatable arm 67. Reference numeral 63 is applied to a pin for supporting the stop-changing plate 44.

A couple of retainers 70 are symmetrically formed in an end of the shaft 65 of the lens holder 61. A couple of grooves 71 into which the retainers 70 are inserted is formed in the boss 66 of the shutter-speed changing lever 64. When the shutter-speed changing lever 64 is attached to the shaft 65, the shaft 65 is inserted to the boss 66 so as to fit the retainers 70 in the groove 71, and then the shutter-speed changing lever 64 is slightly rotated after inserting the shaft 65 until the retainer 70 has reached above the boss 66. Thereby, the top face of the boss 66 is held by the retainer 70.

A changeover ring 72 is rotatably fitted around a lens barrel 62 of the lens holder 61. The changeover ring 72 is provided with a pair of clamp pins 73b, 73c interposing the projecting piece 68 of the shutter-speed changing lever 64 in between. Since the basic structure of the changeover ring 72 is the same as the changeover ring 46 shown in FIG. 3, the explanation is omitted.

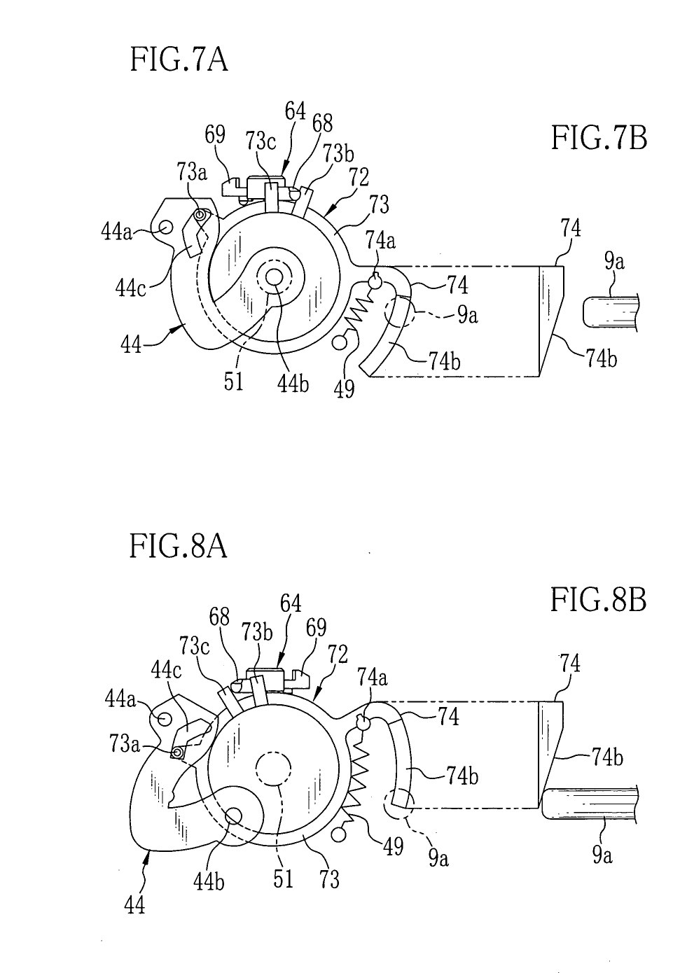

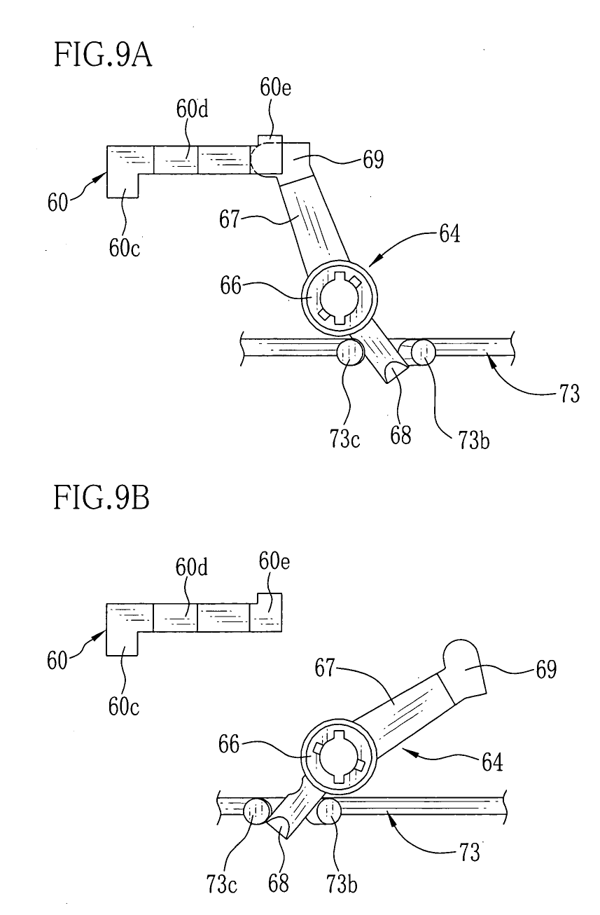

As shown in FIGS. 7A and 7B, when the stop changing button 9 is not pressed, the bar member 9a is away from an extended portion 74 of the changeover ring 72. When the changeover ring 72 is kept in the initial position, the stop-changing plate 44 is inserted into the lens barrel 62, such that the small aperture 44b is placed on the photographing optical axis. And at the same time, the shutter-speed changing lever 64 is supported at a high-speed shutter position shown in FIG. 9A.

The larger-stop state is shown in FIGS. 8A and 8B. When the stop changing button 9 is pressed, the bar member 9a presses a pressing surface 74b of the extended portion 74 to rotate the changeover ring 72 in the counterclockwise direction. The stop-changing plate 44 the slit 44c of which is pressed by the link pin 73a retracts from the optical axis by rotating in the clockwise direction, and at the same time, the shutter-speed changing lever 64 rotates to be held in a low-speed shutter position shown in FIG. 9B.

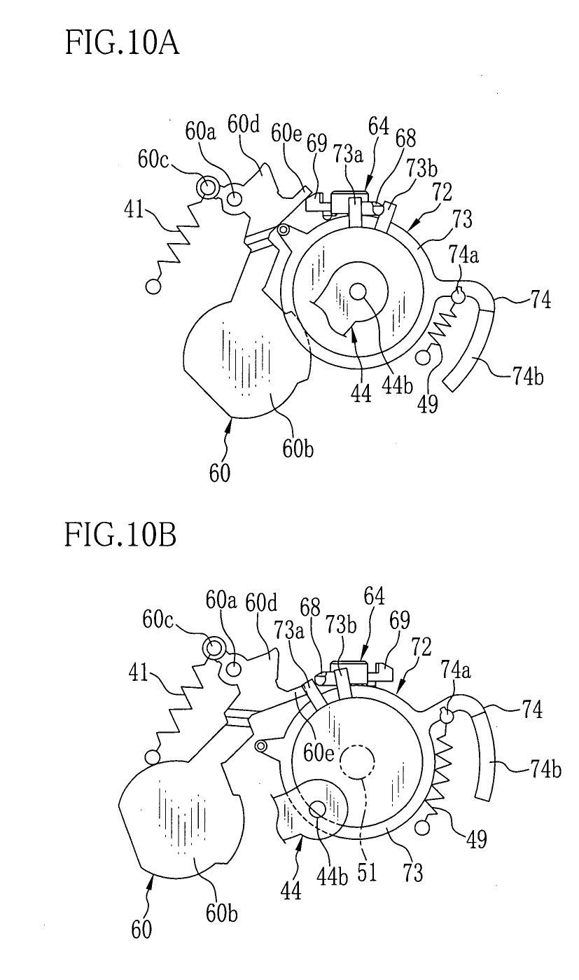

In FIGS. 9A and 9B, the shutter-speed changing lever 64 is rotated by the changeover ring 72. When the shutter-speed changing lever 64 is held in the high-speed shutter position shown in FIG. 9A, the pad 69 is inserted in a rotational orbit of the protrusion 60e of the shutter blade 60. If the shutter release is performed in this state, the protruding portion 60d is kicked by the shutter drive lever to rotate the shutter blade 60, and then the protrusion 60e collides with the pad 69 as shown in FIG. 10A. After the collision, the shutter blade 60 returns to the initial position by the biasing of the spring 41 to cover the small aperture 44b by the open-close portion 60b. The shutter-speed changing lever 64 limits the rotation range of the shutter blade 60 so as to return the shutter blade 60 to the initial position rapidly, so that the shutter speed becomes higher.

As shown in FIG. 10B, when the shutter-speed changing lever 64 is held in the low-speed shutter position, the pad 69 is away from the rotational orbit of the protrusion 60e. If the shutter release is performed in this state, the protruding portion 60d is kicked by the shutter drive lever to rotate the shutter blade 60, and then the protrusion 60e rotates widely until the position shown in FIG. 10B without colliding with the pad 69 after the large aperture 51 is open. After that, the shutter blade 60 returns to the initial position by the biasing of the spring 41 to cover the large aperture 51 by the open-close portion 60b. Since the shutter-speed changing lever 64 does not limit a rotational range of the shutter blade 60, the shutter blade 60 is delayed in returning to the initial position, so that the shutter speed becomes slow.

In the waterproof lens-fitted photo film unit of the second embodiment, the aperture and the shutter speed are changed in accordance with the operation of the stop changing button 9. In such a waterproof lens-fitted photo film unit, for example, an ultrahigh-speed film of ISO 3200 is used as the photographic film 26. In a high-speed shutter/smaller-stop state in which the stop changing button 9 is not pressed, the shutter speed is 1/120 seconds, and the stop is f22 (large exposure value mode). On the other hand, in a low-speed shutter/larger-stop state in which the stop changing button 9 is pressed, the shutter speed is 1/45 seconds, and the stop is f4 (small exposure value mode). The on-land photographing is performed in the large exposure value mode without pressing the stop changing button 9, while the underwater photography is performed in the small exposure value mode with pressing the stop changing button 9.

In the first and second embodiments, although the waterproof lens-fitted photo film unit is provided with the operation member for changing the exposure value which is constituted of the stop changing button 9 to be operated manually in the cover body 5, it may be provided with a pressure driving mechanism for changing the exposure value by driving the changeover ring 46 (72) in response to the water pressure applied to the cover body 5.

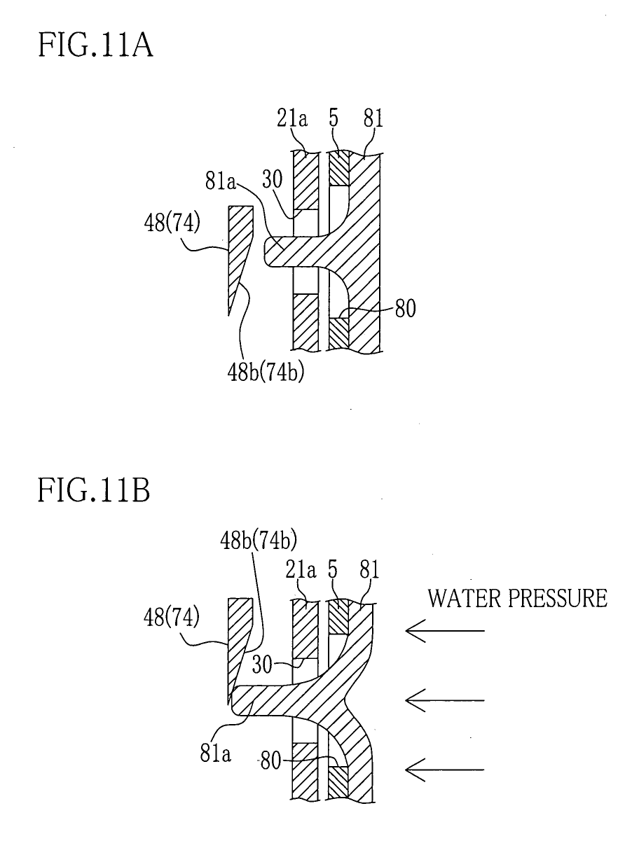

As shown in FIG. 11A, the cover body 5 is formed with an opening 80 instead of the boss 5a shown in FIG. 2. A soft resin film 81 such as elastomer having rubber elasticity at room temperature is provided on an outer surface of the cover body 5 so as to cover the opening 80 in a watertight manner. The cover body 5 is made of opaque plastic harder than the sort resin film 81.

A protruding portion 81a is integrally formed in the soft resin film 81. The protruding portion 81a penetrates the opening 80 and the hole 30 formed in the front cover 21a. As shown in FIG. 11B, when more than a predetermined water pressure is applied to the cover body 5 in the underwater photographing, the soft resin film 81 is elastically deformed, so that the hard protruding portion 81a is moved toward the unit body side. The protruding portion 81a presses the pressing surface 48b (74b), which is provided in the extended portion 48 (74), to rotate the changeover ring 46 (72) as well as the abovementioned bar member 9a of the stop changing button 9, such that the exposure is changed to the large exposure value mode. Since the shape of the soft resin film 81 in the on-land photography is the state shown in FIG. 11A, the pressing surface 48b (74b) is not pressed, so that the exposure is the small exposure value mode. In the on-land photography and the underwater photographing, it is possible to change the exposure value automatically in response to a change in an external pressure.

Although the stop changing mechanism is provided in the lens-fitted photo film unit 4 in the first embodiment, and the stop changing mechanism and the shutter-speed changing mechanism are provided in the lens-fitted photo film unit 4 in the second embodiment so as to change the exposure value, the present invention is not limited to these embodiments. In a third embodiment of the present embodiment, a ND (Neutral Density) filter having a dimming effect is used.

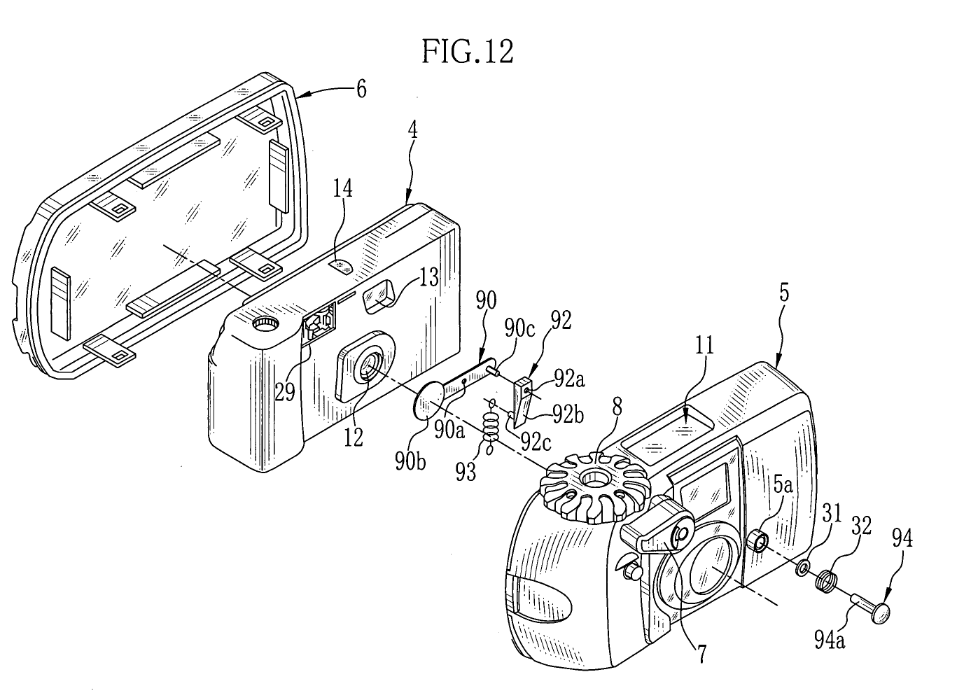

As shown in FIG. 12, a filter changing plate 90 is disposed in the rear surface of the cover body 5. The center portion of the filter changing plate 90 is provided with a hole 90a in which a pin is inserted such that the filter changing plate 90 is swingably supported. A ND filter 90b is provided in one end of the filter changing plate 90, while a pin 90c engaging with a link member 92 is provided in the other end. The link member 92 is provided with a hole 92a in which the pin 90c is inserted such that the link member 92 is swingably supported. The link member 92 has a pressing surface 92b facing the cover body 5. The thickness of the pressing surface 92b is reduced as it goes downward. A spring-hang pin 92c on which one end of a spring 93 is hooked is provided in the rear surface of the link member 92. The other end of the spring 93 is hooked on a pin (not shown) provided in the rear surface of the cover body 5 to bias the filter changing plate 90 in the clockwise direction through the link member 92.

The packing 31 is fitted in the hole of the boss 5a in the front surface of the cover body 5. The spring 32 is assembled on the outer circumference of the boss 5a. A cylindrical bar member 94a is connected to a rear surface of a filter changing button 94. The bar member 94a is inserted to the hole of the boss 5a through the packing 31 to project from the rear surface of the cover body 5. The packing 31 allows sliding movement of the bar member 94a to the cover body 5, and keeps watertightness between the boss 5a and the bar member 94a. the bar member 94a contacts with the pressing surface 92b of the link member 92 when the filter changing button 94 is pressed.

A ND filter 90b is disposed on the photographing optical axis so as to cover the front surface of the taking lens 12 when the bar member 94a is away from the pressing surface 92b. If the filter changing button 94 is pressed, the bar member 94a presses the pressing surface 92b to move the link member 92 upward. Thereby, the ND filter 90b is retracted from the front surface of the taking lens 12 by rotation of the filter changing plate 90 in the counterclockwise direction.

In the waterproof lens-fitted photo film unit of the third embodiment, it is preferable that the ultrahigh-sensitive film of ISO 1600 is used as the photographic film 26, the shutter speed is 1/140 seconds, the f-number is f10, and the ND density of the ND filter 90b is “0.3”. It is also preferable that the ultrahigh-sensitive film of ISO 3200 is used as the photographic film 26, the shutter speed is 1/100 seconds, the f-number is f8, and the ND density of the ND filter 90b is “1.0”. The photographer can select whether reducing an amount of objective light by the ND filter 90b by pressing the filter changing button 94 or not. The on-land photographing is performed in the large exposure value mode without pressing the filter changing button 94, while the underwater photographing is performed in the small exposure value mode with pressing the filter changing button 94.

As in the variations of the first and second embodiments shown in FIG. 11, a pressure driving mechanism for pressing the pressing surface 92b of the link member 92 according to the water pressure applied to the cover body 5 may be provided instead of the filter changing button 94, so that the ND filter 90b can be inserted in or retracted from the photographing optical axis in response to the change in the external pressure.

In the third embodiment, although the filter changing mechanism is provided in the cover body 5 so that the prior lens-fitted photo film unit can be used without modification, the filter changing mechanism may be provided in the lens-fitted photo film unit 4.

In each above embodiment, although the lens-fitted photo film unit is explained, the present invention is also applicable to a camera having a similar mechanism to the lens-fitted photo film unit.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A waterproof lens-fitted photo film unit in which a lens-fitted photo film unit is contained in a waterproof case in a watertight manner, said lens-fitted photo film unit having a taking lens and a photographic film preloaded therein, said waterproof lens-fitted photo film unit comprising:
an exposure value changing mechanism for changing an exposure value at least between a large exposure value and a small exposure value; and
an actuator for actuating said exposure value changing mechanism from outside of said waterproof case.

2. A waterproof lens-fitted photo film unit as claimed in claim 1, wherein said actuator is an operation member attached to said waterproof case, said operation member changes said exposure value manually.

3. A waterproof lens-fitted photo film unit as claimed in claim 1, wherein said actuator is moved by water pressure applied to said waterproof case to change said exposure value.

4. A waterproof lens-fitted photo film unit as claimed in claim 3, wherein said actuator includes:
a film elastically deformed by the water pressure, said film is attached to a part of said waterproof case; and
a hard protrusion provided inside of said film, said protrusion moves while said film is elastically deformed so as to change said exposure value.

5. A waterproof lens-fitted photo film unit as claimed in claim 1, wherein said exposure value changing mechanism is provided within said lens-fitted photo film unit, said actuator is capable of accessing said exposure value changing mechanism through an opening of said lens-fitted photo film unit.

6. A waterproof lens-fitted photo film unit as claimed in claim 5, wherein said exposure value changing mechanism keeps a smaller-stop state in which a size of an aperture stop is small in said large exposure value, and keeps a larger-stop state in which said size of said aperture stop is large in said small exposure value.

7. A waterproof lens-fitted photo film unit as claimed in claim 6, wherein said exposure value changing mechanism includes a stop plate in which a small size opening is formed, said stop plate is set on an optical axis of said taking lens in said large exposure value, and is away from said optical axis in said small exposure value.

8. A waterproof lens-fitted photo film unit as claimed in claim 5, wherein said exposure value changing mechanism sets shutter speed high in said large exposure value, and sets said shutter speed low in said small exposure value.

9. A waterproof lens-fitted photo film unit as claimed in claim 1, wherein said exposure value changing mechanism includes a ND filter provided within said waterproof case, said ND filter being set on an optical axis of said taking lens in said large exposure value, and being away from said optical axis in said small exposure value.
